(19) United States
(12) Patent Application Publication
(10) Pub. No.: US 2004/0015475 A1
(43) Pub. Date: Jan. 22, 2004

(54) Method and system for electronically registering and providing information on the use of a public transport facility

(76) Inventor: Leonard Scheepsma, Capelle (NL)

Correspondence Address: John Han, 6300 Legacy Drive, M S EVW 2 C 2, Plano, TX, 75024, US

(21) Appl. No.: 10/221,586

(22) PCT Filed: Mar. 14, 2001
(86) PCT No.: PCT/NL01/00215

(30) Foreign Application Priority Data
Mar. 15, 2000 (NL) 1014655

(51) Int. Cl. G06F 7/00

(52) U.S. Cl. 707/1

(57) ABSTRACT

A method and a system (1) for electronically registering the use of a public transport facility (3), such as a bus, a train, a tram, the underground, a taxi or the like. The passenger is equipped with a wireless communication device (7, 8) carrying identity data (9), which is suitable for communication with a local communication infrastructure (2) associated with a respective public transport facility (3). The local communication infrastructure (2 ) is arranged for automatically registering the identity data of the communication device (7, 8) upon commencement of the transport automatically registering the identity data of the communication device (7, 8) upon termination of the transport, automatically registering further data relating to the distance travelled and the time between the two identity data registrations and exchanging the registered data with remote processing equipment (5).

The invention relates to a method and a system for electronically registering the use of a public transport facility, such as a bus, a train, a tram, the underground, a taxi and the like.

In present-day public transport, physical, paper tickets are still predominantly used, which tickets are bought or validated by a passenger before commencement of the transport.

Rapid developments in electronic data processing have led to the introduction, albeit on a modest scale, of systems wherein the paper ticket has been replaced by an electronic “ticket” on a so-called intelligent data carrier, also known as smart card in English professional literature.

Like the paper ticket, this electronic ticket is validated upon commencement of the trip at the railway station or the bus station, or in the train, the bus or the taxi itself.

Verification of the authority to travel, that is, the validity of the paper or electronic ticket, is carried out by a train or tram conductor, bus driver, taxi driver and/or at the railway station or the bus station by a competent official of a public transport company.

With such an electronic ticket, the point in time at which the traveller leaves the public transport facility in question at the end of his trip is not registered, no more than with the usual paper ticket.

As a consequence of this, the only information a public transport company can derive from the tickets is information relating to the number of passengers and their destinations upon commencement of the trip, and that only of those passengers who actually purchase a ticket upon commencement of the trip. It is not possible to derive from the tickets the actual number of passengers that use a public transport facility at a particular point in time, since passengers can also travel on the basis of a season ticket, which season tickets are valid for a period of, for example, one month or one year for a specific route or for all public transport facilities of a public transport company.

When a public transport company wishes to gain an insight into the actual passenger flows, separate counts of the number of passengers need to be made. This is a very time-consuming and costly way of data processing.

It has been found that data on the actual use of public transport facilities, which is important to a public transport company, can be obtained in a more efficient manner by registering every passenger both upon commencement and upon termination of the transport. From this data the public transport company can derive information with regard to the planning of material and personnel. Valuable information can be derived from the transport behaviour of passengers at specific moments to and from specific destinations, inter alia for marketing purposes.

When paper tickets are used, registration upon termination of the trip is a major problem. One possibility is to collect the paper ticket when the passenger leaves the public transport facility. In fact this is only a solution for passengers for a single trip, however, and by no means for season ticket holders, for example. Manual registration is too costly, too time-consuming and too slow for processing large passenger flows.

One problem involved in the use of electronic tickets, such as smart cards, is that the passengers are required to carry out an operation in order to enable an efficient registration, such as inserting the smart card into a suitably positioned reading device in order for the transport information in question to be read. When special systems are used, by means of which contactless registration is possible, for example, it will be necessary to force the passengers to pass a specific registration environment, such as registration, detection or access gates.

Examples of the latter systems are disclosed in, among other documents, International patent application WO 00/31691, European patent application EP 0 465 456 and European patent application EP 0 628 928.

From European patent application EP 0 848 360 there is known a payment system for use of a public transport facility such as a bus, a train, a tram, the underground, a taxi or the like, wherein a passenger is equipped with a wireless communication device in the form of a mobile telephone. Also this system uses access gates, which the passenger must pass before receiving authorisation to use the public transport facility. Upon leaving the public transport facility, the passenger must pass an exit gate, which is opened by means of a signal delivered by the transport company after a code transmitted by the mobile telephone has been registered. The data obtained from the mobile telephone at the access gate and the exit gate are used by the public transport company for automatic settlement of the charges connected with the use of the public transport facility in question.

One drawback of these prior art solutions, however, is the possibility of congestion or delay when large numbers of passengers leave a public transport facility such as a train or the underground at the same time. This is undesirable, of course, and will not find acceptation among passengers.

Consequently, it is a first objective of the invention to provide an improved method for electronically registering the use of a public transport facility, by means of which data relating to the use of public transport facilities can be obtained in a reliable manner without the passengers' freedom upon entering and leaving a public transport facility being restricted or affected by a particular operation or other-wise. That is, ideally a passenger must not be required to perform any operation upon commencement of transport or upon termination thereof.

The invention solves this problem by providing a method for electronically registering the use of a public transport facility, such as a bus, a train, a taxi or the like, wherein a passenger is equipped with a wireless communication device carrying identity data, which is suitable for communication with a local communication infrastructure associated with a respective public transport facility, which method comprises the steps of using the local communication infrastructure for:

automatically registering the identity data of the communication device upon commencement of the transport;

automatically registering the identity data of the communication device upon termination of the transport;

automatically registering further data relating to the distance travelled and the time between the two identity data registrations; and

exchanging the registered data with remote processing equipment.

The method according to the invention is based on the insight that the present generation of wireless communication devices, such as wireless or mobile telephones, cordless portable computers, also called laptops, palmtops and organizers in English professional literature, can be used advantageously for the purpose of the invention. These wireless communication devices comprise at least one registration carrier, also indicated by the acronym SIM or Subscriber Identification Module, which carries unique identity data by means of which the user of a communication device and the communication device itself can be identified and registered unequivocally. By adapting the communication devices in question for data exchange with a local communication infrastructure in or on a public transport facility, said identity data can be efficiently collected, in a manner which is not perceptible to the passenger, without burdening the passenger with additional operations. This identity data, together with further information relating to the distance and the time travelled, can then be exchanged with remote processing equipment for further processing.

The use of a local communication infrastructure associated with a particular public transport facility for exchanging the identity data and, if desired, other data relating to the transport provided is important thereby in order to prevent passenger identity data being incorrectly registered by public transport facilities, such as trains, buses and the like other than the one the passenger in question is currently using. All this, however, whilst retaining the possibility of registering the desired data “spatially”, that is, without the presence of detection, access or exit gates being required.

In another embodiment of the method according to the invention, in order to make it possible for the passenger to give permission for said registration, the step of automatically registering the identity data upon commencement of transport comprises the delivery of a registration confirmation signal by the passenger via his wireless communication device.

With this registration confirmation signal, possible unwanted registration or incorrect registration can be prevented, whilst the passenger indicates that he or she agrees to a transaction. The registration confirmation signal can be delivered in response to a request transmitted to the wireless communication device by the local communication infrastructure, for example in the form of an audio signal and/or a visual display, such as a text in the form of a question, a graphic signal, a special sound, a spoken text, etc. Subsequently, the passenger can deliver the registration confirmation signal, for example by pressing a yes/no button or another suitable code or input facility on the communication device.

It stands to reason that in this embodiment of the method according to the invention the registration confirmation signal only needs to be delivered when the passenger has an opportunity to do so, for example after having seated himself or herself in a respective public transport facility.

In yet another embodiment of the invention, instead of using identity data stored in the SIM registration carrier, the wireless communication device is provided with identity data for registration purposes, for example in the form of one or more software tokens or the like stored within the communication device. Such a software token can be stored within a passenger's wireless communication device by a public transport company, for example, when the passenger indicates that he or she wishes to use the services of the public transport company in question. Registration of the respective identity data can take place in various manners in that case, among which remote registration, for example, by establishing a communication link with the public transport company in question for the purpose of exchanging the data in question. Another possibility is to manually input a specific code, which has been received by mail or other means of communication, into a wireless communication device.

In particular when the registration confirmation signal is being used, it is necessary to verify the registration of a communication device for use of a respective public transport facility. To this end, the method according to the invention provides a further step, wherein the communication device is validated on the basis of the identity data. Preferably, said validation comprises the exchange of electronic certificates with the communication device. In a certain sense, said certificates can be taken to be the “electronic variant” of the paper ticket.

In another embodiment of the method according to the invention, in order to provide maximum verification of the certificates, that is, not only inside a public transport facility but also upon entering or leaving stations and the like, the certificates contained within in a communication device are available for verification of the validity of a certificate upon commencement, during and/or upon termination of the transport.

In order to rule out fraud and misuse as much as possible, it is advisable to exchange the certificates in an encoded manner.

In another embodiment of the method according to the invention, in order to have a possibility of verifying the registration of a communication device at the local communication infrastructure, regardless of the exchange of electronic certificates, a verifiable characteristic, such as a verification code, is exchanged with a communication device via the local infrastructure by means of a verification device. Said verification code may depend on the verification device and it may vary with each individual ticket inspector or collector. By ensuring that the verification code in question is only exchanged with registered communication devices, and by providing a simple visual or auditive presentation of the verification code, which can be retrieved via the verification device, if necessary, a ticket inspector or collector can verify in an efficient manner, both in a public transport facility and at a station or the like, whether the identity data associated with a communication device are registered.

The local communication infrastructure periodically and automatically scans its communication environment for the purpose of registering communication devices, in order to be able to process large passenger flows in a quick and efficient manner. A high degree of efficiency can be achieved by arranging the communication devices in such a manner that registration is possible at all times, also of communication devices that are not activated for communication purposes. That is, the communication devices are operative in such a manner that registration via the local communication infrastructure is possible at all times.

By storing the registered data in the local infrastructure temporarily, and transferring said data to the remote processing equipment as a whole at the end of a registration cycle, the necessary flexibility for registering and processing data of a large number of passengers and a large number of public transport facilities is obtained.

In an embodiment of the method according to the invention, the remote processing equipment is arranged for performing at least the following functions:

acquiring data registered by a local communication infrastructure;

processing the registered data for the purpose of generating transport data comprising information about the transport provided to a passenger; and

charging the passenger for the transport that has been made available to him on the basis of a predetermined fare structure.

The transport data generated by the remote processing equipment comprises information relating to, for example, the number of kilometres travelled by the passenger, the class of transport, the times at which transport took place, the duration of the transport, the number of changes, any delays that have been encountered and the like. This transport data constitutes the basis for charging the passenger for the transport that has been made available to him, which may take place on the basis of a predetermined fare structure. That is, different fares may apply for different times, routes, numbers of kilometres travelled and the like. Those skilled in the art will appreciate that in fact there is no limit as to the form in which and the terms on which fares are fixed when using the method according to the invention.

The availability of the identity data makes it possible to opt for a method for actually settling the charges of the transport that has been made available to a passenger on a prepayment basis, for example by debiting a value associated with the identity data, which is stored in a prepayment file, with the transport charges in question. Furthermore it is possible to settle the transport charges by means of an electronic transaction with the communication device, such as debiting a value stored in the communication device or in a file that can be accessed from the communication device with said transport charges.

The time at which settlement of the transport charges takes place, that is, upon commencement, during or after termination of the transport, determines, among other things, the flexibility and the ease with which passengers can use a public transport facility.

The most flexible and easy method of travelling is one wherein the passenger, or the identity data of the associated communication device, is registered at the beginning and at the end of the trip and the charges in question are settled on the basis of said registrations. In that case the passenger only needs to ensure that the stored value is sufficient for being debited with the transport charges. The passenger does not need to purchase a ticket, therefore, or carry out operations connected with the transport in any other manner.

According to another possibility, on the other hand, the passenger is validated in advance, for example for travelling a particular route a number of times, or even an unlimited number of times, or wherein the passenger requests unlimited access to all public transport facilities, for which he pays in advance. In the latter case all that is necessary is registration and validation of a respective communication device each time the passenger in question uses a public transport facility. In the case of advance validation of authorization to use a particular route, it must be verified whether the passenger is actually using the route in question, whereby also the aforesaid certificate or another electronic variant of the paper ticket is provided, depending on the information that has been registered in advance, so that verification is possible.

The invention makes it possible to collect data during a trip and to process said data entirely “back-office”. This also enables dynamic determination of the quality of the transport that has been provided. This means that when the quality of the transport provided is below a level guaranteed or aimed at by a public transport company, compensation in the form of, for example, financial compensation or a refund or a reduction of the money charged for the transport is possible. It will be understood that the current “money refunded scenario” which obtains for rail travel in the Netherlands, for example, can thus be realised in a simple and reliable manner.

To those skilled in the art it will be apparent that the method according to the invention offers a great many variants, whereby passengers can make use of a public transport facility in an easier, more flexible and more efficient manner than is possible with the current paper tickets.

Furthermore it will be understood that the method according to the invention, on account of its registration facilities, directly provides valuable transport data that can be used for marketing purposes and/or for staff management, planning and/or maintenance purposes.

Since the invention is based on communication taking place between a communication device and a local communication infrastructure, one embodiment of the method according to the invention arranges for the exchange of additional information and data on arrival and departure times, including delays, deviations from the timetable and, if desired, commercial travel information associated with the transport being provided, among which special offers and the like. Since the identity of the passenger is known, the invention makes it possible to personalise said additional information, that is, to gear said information to the passenger's personal requirements, to which end a passenger profile may be stored in, for example, the remote processing equipment, if desired.

The invention furthermore provides a system for electronically registering the use of a public transport facility, such as a bus, a train, a taxi or the like, comprising a local communication infrastructure, wherein a passenger is equipped with a wireless communication device carrying identity data, which is arranged for communication with the local communication infrastructure associated with a respective public transport facility and with remote processing equipment, which system is arranged using the local communication structure for:

automatically registering the identity data of the communication device upon commencement of the transport;

automatically registering the identity data of the communication device upon termination of the transport;

automatically registering further data relating to the distance travelled and the time between the two identity data registrations; and

exchanging the registered data with remote processing equipment.

In another embodiment, the system according to the invention may be arranged for having the automatic registration of the identity data of a communication device upon commencement of transport take place in dependence on a registration confirmation signal to be delivered by the passenger via his wireless communication device.

The delivery of the registration confirmation signal can be initiated by the local communication infrastructure by sending a registration request to the communication device, for example in the form of a graphically displayed or a spoken text, another audio signal, graphic symbols on the display of the communication device and the like. The passenger can respond by pressing a yes/no button or by providing confirmation in another way, for example by recording a spoken message or otherwise. It is noted that the registration confirmation signal is provided via the wireless communication device of the passenger himself, so that the act of registration remains free from interactions with external equipment, such as a reading device disposed on a platform or in a public transport facility or the like, thus preventing congestions and delays when large passenger flows are to be processed.

In yet another embodiment of the invention, the system is arranged for retrieving identity data from the SIM card that is present in a wireless communication device, or from a so-called software token or tokens which is (are), for example, specially stored within the wireless communication device for use in public transport facilities, for example if different public transport companies each wish to use their own identity characteristic. Said software token is associated with the passenger's identity data, and it can be stored within the wireless communication device by effecting a communication link with one br more public transport companies, or by manually inputting a code or the like, for example.

In another embodiment, the system comprises a verification device for exchanging a verifiable characteristic, such as a verification code, with a communication device via the local communication infrastructure for the purpose of verifying the registration of a communication device. This verifiable characteristic can be communicated to a ticket inspector or collector in the form of a message on a display of the communication device, for example, or by means of an audio signal upon verification with the verification device.

In a preferred embodiment of the system according to the invention, the local communication infrastructure is arranged for periodically and automatically scanning its communication environment, and it comprises storage means for the temporary storage of registered data and means for transferring said data as a whole at the end of a registration cycle. Both aspects, which can be implemented independently or in combination with the system according to the invention, enable an efficient, flexible and quick registration for processing large passenger flows of a large number of means of public transport facilities.

In an embodiment of the system according to the invention, the remote processing equipment includes means for carrying out at least the following functions:

acquiring data registered by a local communication infrastructure;

processing the registered data for the purpose of generating transport data comprising information about the transport made available to a passenger; and

charging a passenger for the transport that has been made available to him on the basis of a predetermined fare structure.

In another embodiment of the invention, the system comprises means arranged for settling the transport charges by debiting a value stored in a prepayment file and/or means for debiting a value stored in a communication device or in a file which can be accessed from a communication device.

Preferably, the communication device and the local communication infrastructure of the system according to the invention are arranged for the exchange of additional (personalized, if desired) information and data relating to the transport.

One possibility in this connection is the provision of Internet-related services via a so-called Portal of the public transport company, the execution of financial transactions other than paying for a ticket, such as paying for tidbits, coffee, et., as well as a series of supportive applications of the public transport company itself, such as the provision of (silent) video images, internal communication between various staff members, request for assistance from disabled persons, etc.

In a preferred embodiment of the system according to the invention, the local communication infrastructure can be installed either on or near an access facility, such as a bus or train station, so that it is possible to register the presence of a passenger in a public transport facility as well as said passenger's presence at an access facility. In fact this means that the passenger already enters into a transaction with a public transport company on the platform, for example. Also in this case additional services can be made simultaneously available via the local communication infrastructure, for example providing the passengers with information about the expected departure and arrival times, delays, etc. It will be understood that said services can also be implemented in a public transport facility via the local communication infrastructure.

In an embodiment of the system according to the invention, the local communication infrastructure is preferably built up of one or more wireless base or access stations having adjoining or overlapping communication environments, storage means for the temporary storage of data registered by said base or access stations, and means for wireless exchange of registered data with processing equipment.

In a preferred embodiment of the invention, in order to prevent undesirable registration, for example of public transport facilities passing each another, said base or access stations are arranged for radio communication within a communication range in the order of 10 m.

A local communication infrastructure which is suitable for the purpose of the invention may comprise base or access stations, communication devices of passengers as well as verification devices suitable for radio communication in accordance with the so-called Bluetooth standard.

In another embodiment of the system according to the invention, communication between the local communication infrastructure and the remote processing equipment advantageously takes place radiographically in accordance with a mobile communication standard, such as GSM

(Global System for Mobile Communications).

It will be understood by those skilled in the art, of course, that other communication standards, provided they have sufficient communication capacity, are suitable for the purpose of the invention.

The invention furthermore provides a public transport facility comprising a local communication infrastructure; a communication device comprising means for communication with a local communication infrastructure, a verification device arranged for use in combination with a local communication infrastructure and communication means, as well as remote processing equipment, each including processor means, communication means and data storage means arranged for use in the system and in accordance with the method as described in the above.

The invention can be realised by means of commercially available equipment (mobile telephones, laptop computers, etc.) using standard communication protocols (Bluetooth, GSM and others). This means that a passenger does not need to purchase new hardware or equipment or, which is even more advantageous, that a passenger does not need to carry any additional equipment besides, for example, his mobile telephone, in order to be able to make use of a public transport facility. It will be understood that this is quite advantageous, not only from an economic viewpoint but also from a viewpoint of convenience.

The invention will now be explained in more detail by means of a possible embodiment of a system, whereby it is noted that the invention is not limited to the embodiment described herein.

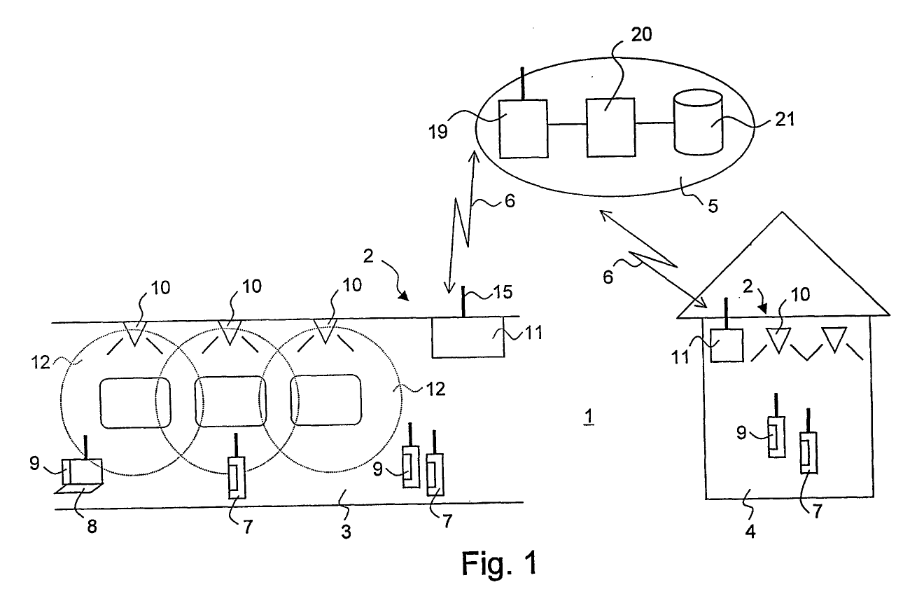

FIG. 1 schematically shows a system according to the invention for electronically registering t he use of a public transport facility, in this embodiment in the form of a local communication infrastructure which is installed in a public transport facility, such as a train, and on an access facility, such as a station.

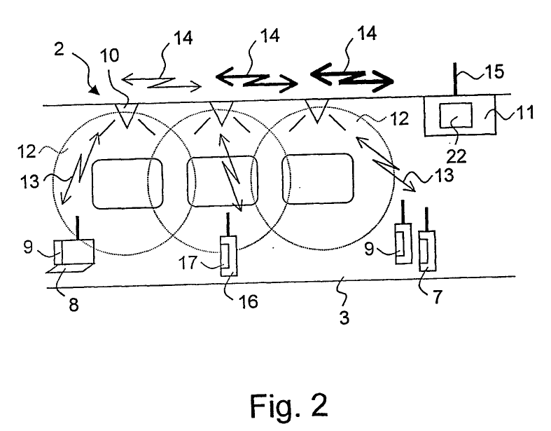

FIG. 2 schematically shows the exchange of data between wireless communication devices and the local communication infrastructure in the public transport facility according to FIG. 1.

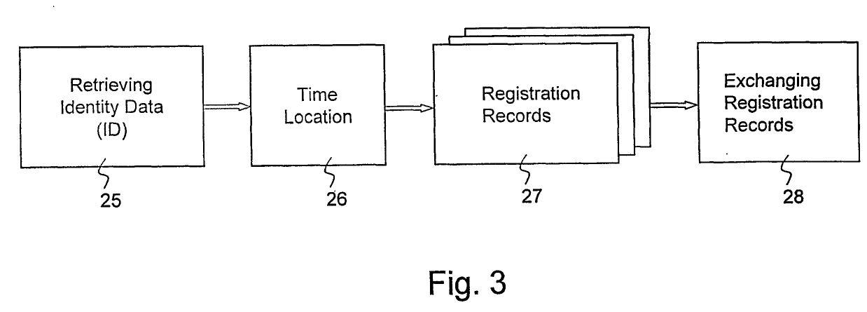

FIG. 3 shows the various steps of the method for the registration of identity data by the local communication infrastructure and the exchange thereof with remote processing equipment.

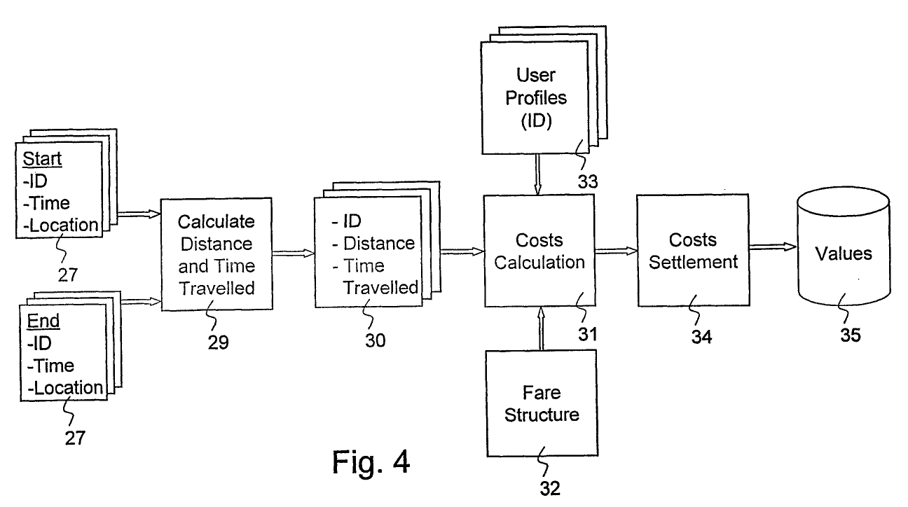

FIG. 4 schematically shows the method according to the invention for processing the registered data in the remote processing equipment.

FIG. 1 shows a system for electronically registering the use of a public transport facility, such as a bus, a train, a tram, the underground, a taxi or the like, which system as a whole is indicated by numeral 1.

In the most general embodiment, system 1 comprises a local communication infrastructure 2 installed in or on a public transport facility 3, such as a train, and on or near an access facility 4, such as a train station. System 1 furthermore comprises remote processing equipment 5 for the exchange of data with a local communication infrastructure 2.

In a preferred embodiment of the system 1 according to the invention, the local communication infrastructure 2 is formed by one or more wireless base or access stations 10, which have a wire connection or a wireless communication link with local server and storage means 11. The wireless base or access stations 10 are preferably arranged to have overlapping communication ranges 12. This is done in order to effect full coverage of the space within public transport facility 3 or access facility 4 so as to enable communication with communication devices carried by the passengers, such as wireless telephones 7 or wireless portable computers.

In a preferred embodiment of the local communication infrastructure 2 for use in the system according to the invention, the base or access stations 10 operate in accordance with the so-called Bluetooth standard.

Bluetooth comprises radio communication in the ISM frequency band at 2,45 GHz. The transmission capacity ranges between 1 and 100 mW. This enables the use of very small transceivers, which require little battery capacity. One small battery enables a Bluetooth unit to operate 24 hours a day for the duration of a few months. The nominal distance between two base or access stations 10 according to the Bluetooth standard is about 10 m, with a possible extension to 100 m. The maximum bit speed is 1 Mbit/s, with the effective information exchange rate being about 720 kBit/s, due to communication overhead.

When said base or access stations 10 are mounted against the ceiling of a public transport facility, such as a train, at intervals in the order of 10 m, for example, it is possible to provide a range of coverage extending in the longitudinal direction of the train.

Besides suitable transceiver means 19, the remote processing equipment 5 also comprises processor means 20 and data storage means 21.

Let us now consider FIG. 2. The communication devices 7, 8, which are fitted for wireless radio communication in accordance with a cellular communication standard which is known per se, such as GSM (Global System for Mobile communications) or DECT (Digital Enhanced Cordless Telecommunications), are also suitable for communication via a radio communication 13, using the Bluetooth communication standard, with a respective base or access station 10, within the reach 12 of which a communication device 7, 8 is located. The communication of a base or access station 10 with the local server and storage means 11 takes place in a cascade-like manner, as is indicated by communication arrows 14, wherein the thickness of arrows 14 is representative of the amount of information that is exchanged between the base or access stations 10 mutually and between said base or access stations and the server and storage means 11.

The communication devices 7, 8 may be well-known wireless or mobile telephones, portable computers, etc., which are adapted for communication in accordance with the Bluetooth standard, and that in such a manner that communication with a local communication infrastructure 2 is possible also in those cases in which a respective communication device 7, 8 is operative for communication purposes or used otherwise.

The communication devices 7, 8 each comprise retrievable identity data, for example in the form of one or more user identification modules 9, also indicated by the acronym SIM (Subscriber Identification Module), which are present in a communication device 7, 8, and/or one or more so-called software tokens or other software-stored information representative of identity data. The software tokens can be registered in the communication device 7, 8 through data exchange with one or more public transport companies, or by the manual inputting of a code or the like by a user. The identity data in question can be retrieved via the local communication infrastructure 2.

In a preferred embodiment of the invention, radiographic data exchange 6 takes place between the server and storage means 11 and the remote processing equipment 5, using the GSM (Global System for Mobile communications) standard, to which end the server and storage means 11 are provided with suitable transceiver means 15. GSM is a well-known radio communication standard, which need not be explained in more detail to a person skilled in the art.

The advantage of using standardized radio communication means such as Bluetooth and GSM is that the invention can be realized quickly, using equipment that is being used in practice, so that no additional investments in new communication technology and the like are needed.

In addition to being used with Bluetooth and GSM as the communication standards, the invention can also be used with any wireless local communication infrastructure and means for transmission of data to remote processing equipment. The latter may thereby comprise wire communication means, if necessary, such as the power supply lines of trains, trams or the underground, for example.

In FIG. 2, numeral 16 indicates a verification device for verifying the registration of a communication device, such as a mobile telephone 7 or a portable, cordless computer 8. Verification device 16 is held by a ticket collector or inspector, and it preferably includes a registration carrier 17 comprising a unique code, which can be retrieved from registered communication devices 7, 8 or which can be verified in another manner.

The local communication infrastructure 2 comprises means 22, for example in the server and storage means 11, from which data relating to the time and the distance covered by public transport facility 3 can be retrieved. Registration of the time may take place, for example, by well-known clock means that provide the actual time of day and the date, for example, or means that provide a relative time value, for example the difference in time between commencement and termination of the transport along a respective route. The means for providing information on a distance travelled by means of public transport facility 3 may employ the well-known GPS (Global Positioning System), for example, or be arranged otherwise for providing information on the geographic position or on the number of kilometres between two stations, for example. Such means are known per se in the industry and need not be explained in more detail to a person skilled in the art. It will be understood that the server and storage means 11 at a station or the like need not necessarily be provided with means for determining the geographic position. After all, said position is known, so that an identification code of the respective server and storage means 11 will suffice.

FIG. 3 is a global overview of the steps that are carried out by a local communication infrastructure 2 for registering communication devices 7, 8.

In a first step 25, the local communication infrastructure 2 retrieves identity data (ID), via base or access stations 10, from the communication devices 7, 8 that are present within the range covered by a base or access station 10. Said information is available in the SIM card 9 of a communication device 7, 8 and/or in one or more separate software tokens stored within a communication device 7, 8.

The retrieval and registration of the identity data preferably takes place fully automatically, but it is also possible to use an intermediate step, wherein the passenger is required to deliver a registration confirmation signal from his communication device 7, 8, for example by pressing a yes/no button on the communication device or by recording a message or by using any other means for inputting information and transmitting said information to the local communication infrastructure 2 via a communication device 7, 8. By delivering the registration confirmation signal, in particular upon commencement of the use of a public transport facility, the passenger clearly indicates that he or she wishes to enter into a transaction with a public transport company or the like.

Delivery of the registration confirmation signal can take place, for example, on the basis of a registration request which the local communication infrastructure 2 transmits to a communication device 7, 8. Said registration request may be an auditive or a visual signal, such as a special tone, a spoken text, a written text or any other symbol or image or the like to be represented on the display of a communication device 7, 8.

The local communication infrastructure 2 then adds to the identity data information relating to the time and the location of registration 26. The data thus registered is stored in the local server and storage means 11, for example in the form of a multitude of registration files or records 27.

The information or records 22 stored is (are) subsequently exchanged 23 with the remote processing equipment 5.

Steps 25-28 are in any case carried out upon commencement and upon termination of the transport, and furthermore as often as is considered necessary during the trip. In the case of transport by train, tram, the underground or by bus, registration preferably takes place both inside a vehicle and on a respective boarding and disembarking station.

Depending on the result of the registration of a communication device 7, 8, the local communication infrastructure 2 can validate a communication device 7, 8 by the exchange 13 of an electronic certificate with said communication device as the electronic equivalent of the paper ticket. In order to prevent fraud and the like, said certificates are preferably transferred cryptographically or in another secure manner. Said certificates preferably remain available in a communication device 7, 8 for verification during transport and on a station or the like. Afterwards the certificate can be deleted independently by a communication device, for example.

Verification of the registration of a communication device 7, 8 may also take place by means of a verification device 16, by means of which a verifiable characteristic 17, such as a unique verification code, can be exchanged with a communication device 7, 8 via local communication infrastructure 2. To that end the local server and storage means 11 are so arranged that said verification code is only exchanged with communication devices 7, 8 that are registered with the local communication infrastructure in question. By suitably presenting the verification code on a communication device 7, 8, for example via display means thereof, or by making the verification code auditively retrievable, a ticket inspector or collector who is in possession of a verification device 16 can easily verify whether a respective communication device 7, 8 is indeed registered. This in order to prevent the so-called fare dodging.

FIG. 4 schematically shows the steps that are carried out by the remote processing equipment 5 in connection with validating and charging communication devices and for statistical and other information purposes.

Remote processing equipment 5 receives from the various local server and storage means 11 registration records 27 of the individual communication devices 7, 8 at least upon commencement and termination of the transport.

From said registration records 27, the distance and the time travelled are determined for each communication device in step 29, which results in detailed transport records 30 with regard to the distance and the time travelled in relation to the identity data ID from a communication device 7, 8. This completes the data processing process, after which the charges connected with the transport that has been made available can be calculated and charged.

The information contained in the transport records 30 is then suitably processed in step 31 on the basis of a specific fare structure 32 and data specific to a respective passenger or user from user profiles 33.

Said user profiles 33 may contain information about, among other things, the debiting of predetermined values, billing data, data on transport discounts, etc. The fare structure data 32 comprise, if applicable, various fares, depending on the time of the transport, the route, discounts in case of delays, etc.

User profiles 33 can also be used for providing a passenger or user with travel information and the like geared to the passenger or user in question, which is an important additional feature of the system according to the invention.

The transport records 30 thus processed result in settlement records 34 and, eventually, settlement of the transport charges against the stored values 35 or otherwise. This includes not only the debiting of values in prepayment files, but also, for example, the debiting of a value stored in a respective communication device 7, 8, for example in accordance with a technique which is known as “Wireless Wallet”.

It will be understood that the data from the transport records 30 can be used advantageously for statistical, planning, maintenance and marketing purposes.

In summary, the method and the system according to the invention as presented in the above by means of an embodiment thereof provide a completely new and innovative manner of settling the charges connected with the use of public transport facilities, whereby in fact the only operation a passenger needs to carry out is to provide identity data, and that only once. It will be understood that the method and the system according to the invention provide maximum flexibility in transport, and that they are suitable for processing data of large passenger flows in a quick and efficient manner.

1. A method for electronically registering the use of a public transport facility, such as a bus, a train, a tram, the underground, a taxi or the like, wherein a passenger is equipped with a wireless communication device carrying identity data, which is suitable for communication with a local communication infrastructure associated with a respective public transport facility, which method comprises the steps of using the local communication infrastructure for:
automatically registering the identity data of the communication device upon commencement of the transport;
automatically registering the identity data of the communication device upon termination of the transport;
automatically registering further data relating to the distance travelled and the time between the two identity data registrations; and
exchanging the registered data with remote processing equipment.

2. A method according to claim 1, wherein the step of automatically registering the identity data upon commencement of the transport comprises the delivery of a registration confirmation signal by the passenger via his wireless communication device.

3. A method according to claim 2, wherein said registration confirmation signal is delivered in response to a registration request signal that is delivered to the wireless communication device by the local communication infrastructure.

4. A method according to claim 1, 2 or 3, wherein the communication device is validated via the local communication infrastructure on the basis of the identity data for the purpose of authorizing the transport.

5. A method according to claim 4, wherein said validation comprises the exchange of electronic certificates between the local communication infrastructure and the communication device.

6. A method according to claim 5, wherein said certificates are exchanged in encoded form.

7. A method according to claim 5 or 6, wherein said certificates are available in a communication device for verification of the validity thereof upon commencement, during and/or upon termination of the transport.

8. A method according to any of the preceding claims, wherein the registration of a communication device is verified by exchanging a verifiable characteristic, such as a verification code, with a communication device via the local infrastructure.

9. A method according to any of the preceding claims, wherein the local communication infrastructure periodically and automatically scans its communication environment for the purpose of registering communication devices.

10. A method according to claim 9, wherein the communication devices are so arranged that registration is possible at all times, also of communication devices that are not activated for communication purposes.

11. A method according to any of the preceding claims, wherein the registered data is temporarily stored in the local infrastructure and transferred to the remote processing equipment as a whole at the end of a registration cycle.

12. A method according to any of the preceding claims, wherein the remote processing equipment is arranged for performing at least the following functions:
acquiring data registered by a local communication infrastructure;
processing the registered data for the purpose of generating transport data comprising information about the transport provided to a passenger; and
charging the passenger for the transport that has been made available to him on the basis of a predetermined fare structure.

13. A method according to claim 12, wherein the transport charges are settled, for example, on the basis of a prepayment associated with the identity data, which is done by debiting a value stored in a prepayment file.

14. A method according to claim 13, wherein the transport charges are settled by means of an electronic transaction with the communication device, for example by debiting a value stored within the communication device or in a file that can be accessed from said communication device.

15. A method according to claim 12, 13 or 14, wherein statistical data to be used for marketing purposes and/or for staff management, planning and/or maintenance purposes can be derived from the transport data.

16. A method according to any of the preceding claims, wherein said identity data is retrieved from one or more registration carriers, such as a SIM (Subscriber Identification Module) card, which is (are) present in the wireless communication device.

17. A method according to any of the preceding claims, wherein said wireless communication device is provided with identity data for registration purposes, for example in the form of one or more software tokens stored within the wireless communication device.

18. A method according to any of the preceding claims, wherein an exchange of additional information and data, among which information on arrival and departure times, including delays, deviations from the timetable and commercial travel information associated with the transport being provided, takes place between a communication device and the local communication infrastructure.

19. A method according to claim 18, wherein said additional information is geared to specific passengers, to which end a user profile of the passenger in question may be composed and stored.

20. A system for electronically registering the use of a public transport facility, such as a bus, a train, a taxi or the like, comprising a local communication infrastructure, wherein a passenger is equipped with a wireless communication device carrying identity data, which is arranged for communication with the local communication infrastructure associated with a respective public transport facility and with remote processing equipment, which system is arranged using the local communication structure for:
automatically registering the identity data of the communication device upon commencement of the transport;
automatically registering the identity data of the communication device upon termination of the transport;
automatically registering further data relating to the distance travelled and the time between the two identity data registrations; and
exchanging the registered data with remote processing equipment.

21. A system according to claim 20, which is arranged for the delivery of a registration confirmation signal by the passenger via his wireless communication device for the purpose of automatically registering the identity data of the communication device upon commencement of transport.

22. A system according to claim 21, wherein the local communication infrastructure is arranged for delivering a registration request to the wireless communication device.

23. A system according to any of the claims 20-22, comprising a verification device for exchanging a verifiable characteristic, such as a verification code, with a communication device via the local communication infrastructure for the purpose of verifying the registration of a communication device.

24. A system according to any of the claims 20-23, wherein said local communication infrastructure is arranged for periodically and automatically scanning its communication environment.

25. A system according to any of the claims 20-24, wherein said local communication infrastructure comprises storage means for the temporary storage of registered data and means for transferring registered data as a whole to the remote processing equipment at the end of a registration cycle.

26. A system according to any of the claims 20-25, wherein the remote processing equipment includes means for carrying out at least the following functions:
acquiring data registered by a local communication infrastructure;
processing the registered data for the purpose of generating transport data comprising information about the transport made available to a passenger; and
charging a passenger for the transport that has been made available to him on the basis of a predetermined fare structure.

27. A system according to claim 26, wherein said means for settling the transport charges are arranged for debiting a value stored in a prepayment file.

28. A system according to claim 27, wherein said means for settling the transport charges are arranged for debiting a value stored in the communication device or in a file which can be accessed from said communication device.

29. A system according to any of the claims 20-28, wherein said local communication infrastructure is arranged for retrieving identity data from a registration carrier, such as a SIM (Subscriber Identification Module) card, which is present in the wireless communication device.

30. A system according to any of the claims 20-29, wherein said local communication infrastructure is arranged for retrieving identity data from a data characteristic, such as a software token or software tokens stored within the wireless communication device.

31. A system according to claim 30, which is arranged for exchanging one or more software tokens with a communication device for the purpose of registering the identity of a passenger.

32. A system according to any of the claims 20-31, wherein the communication device and the local communication infrastructure are arranged for the exchange of additional information and data, among which information on arrival and departure times, including delays, deviations from the timetable and commercial travel information associated with the transport being provided.

33. A system according to any of the claims 20-32, wherein a local communication infrastructure may be installed on or near an access facility, such as a bus or train station, for the purpose of providing access to a public transport facility.

34. A system according to any of the claims 20-33, wherein the local communication infrastructure is built up of one or more wireless base or access stations having adjoining or overlapping communication environments, storage means for the temporary storage of data registered by said base or access stations, and means for wireless exchange of registered data with processing equipment.

35. A system according to claim 34, wherein said base or access stations are arranged for radio communication, with a communication range in the order of 10 m.

36. A system according to claim 34 or 35, wherein said base or access stations, the communication devices of passengers and the verification devices are arranged for radio communication in accordance with the so-called Bluetooth standard.

37. A system according to any of the claims 34-36, wherein the means for wireless communication with the remote processing equipment are arranged for radio communication in accordance with the GSM (Global System for Mobile communications) standard.

38. A public transport facility comprising a local communication infrastructure according to any of the preceding claims.

39. A communication device comprising means for communication with a local communication infrastructure according to any of the preceding claims.

40. A verification device arranged for use with a local communication infrastructure and communication means according to any of the preceding claims.

41. Processing equipment comprising processor means, communication means and data storage means arranged for use according to any of the claims 1-37.
